(19) United States
(12) Patent Application Publication
(10) Pub. No.: US 2025/0237627 A1
(43) Pub. Date: Jul. 24, 2025

(54) VOLATILE PFAS-FVC ANALYSIS SYSTEM AND METHOD

(71) Applicant: Entech Instruments Inc., Simi Valley, CA (US)

(72) Inventor: Daniel B. CARDIN, Simi Valley, CA (US)

(21) Appl. No.: 19/034,480

(22) Filed: Jan. 22, 2025

Related U.S. Application Data
(60) Provisional application No. 63/623,759, filed on Jan. 22, 2024.

(51) Int. Cl. G01N 30/14; G01N 30/02; G01N 30/72

(52) U.S. Cl. CPC G01N 30/14; G01N 30/7206; G01N 2030/025

(57) ABSTRACT

A primary trap concentrates the sample, followed by forward flushing of retained compounds more volatile than CO₂ to a secondary trap. In some embodiments, prior to CO₂ elution, the primary trap is isolated from the secondary trap and pressure in the primary trap is reduced to sub-atmospheric. At this time, a pressure sensor measures expansion of CO₂ into a vacuum reservoir to determine the amount of CO₂ and CO₂ is removed. Optionally, inert gas is used to eliminate any remaining CO₂, either at positive pressure instead of removing CO₂ under vacuum, or as an optional additional step after removing CO₂ under vacuum. After the CO₂ is removed, the primary trap is heated and backflushed to the secondary trap, which is then preheated and either injected directly to a GCMS, or further condensed using an open tubular focusing trap for even faster injection rates into the GCMS.

### CROSS-REFERENCE TO RELATED APPLICATION

This application claims the benefit of U.S. Provisional Patent Application No. 63/623,759, filed on Jan. 22, 2024, the entire disclosure of which is incorporated herein by reference in its entirety for all purposes.

### FIELD OF THE DISCLOSURE

This disclosure relates generally to sample preparation for GCMS analysis and, more particularly, to removing carbon dioxide (CO₂) from a sample while recovering compounds more volatile than CO₂ and compounds less volatile than CO₂.

### BACKGROUND OF THE DISCLOSURE

Preconcentration systems used to prepare trace level samples for gas chromatography (GC) or gas chromatography-mass spectrometry (GCMS) analysis have been in existence for several decades to enrich the compounds of interest in a large volume of gas phase sample to allow their detection by the GC detector at levels much lower than possible without pre-enrichment. Most GC/GCMS is currently performed using capillary GC columns with flow rates from 0.5 to 2 cc/min, typical. Typical peak widths in a capillary GC run are 3-6 seconds wide. Therefore, the optimum injection time must be about 6 seconds or less. At a flow rate of 1 cc/min, a 6 second injection would require that the sample be limited to a 0.1 cc volume or less. However, in order to reach sub-PPB levels of detection by GCMS, a sample volume of 100 cc or more is typically required. Therefore, 100-500 cc of sample must be reduced to a volume of 0.1 cc or less prior to injection, which would offer an enrichment of 1000 to 5000 times in this example. Typically, the enrichment of target compounds means eliminating the compounds that are of no importance, and/or would otherwise interfere with both the ability to decrease the sample volume to 0.1 cc, or would degrade the performance of the GC/GCMS. In most applications, finding a solution to eliminate the bulk constituents in air without loss of target compounds of interest is possible by finding a combination of sorbents (adsorbents) which, when operated at specific temperatures, allows the removal of N₂, O₂, Ar, and CO₂ without loss of compounds of interest. The final bulk constituent, water, can be removed by using one of many dehydration techniques (cool dehydration trap, chemical dehydration trap, other), or by first condensing all compounds of interest including the water, and then purging the compounds of interest onto a secondary trap while leaving most of the water condensed in the first stage. This approach works because water is often millions of times higher in concentration than the compounds of interest during trace chemical analysis, so post-water-knockout purge volumes can be chosen to bring all compounds of interest back into the gas phase while falling well short of volatilizing all of the condensed water, thereby successfully eliminating the excess water and its effect on the analysis.

Although N₂, O₂, and Ar can be removed through a cold sorbent bed without loss of virtually all compounds of interest, Carbon Dioxide (CO₂) has been problematic with the analysis of many light boiling compounds. CO₂ has its triple point at −78° C., whereby it can exist as a solid, liquid, or gas. Some greenhouse gases and Per-Fluorinated Alky Substances (PFAS) boil even lower than this, and many of these compounds cannot be trapped and retained on any known sorbent at any temperature that allows removal of CO₂ during the preconcentration process. Various preconcentration systems used for greenhouse gas measurements down to sub-part per trillion levels (sub-ppt) actually measure CO₂ concentration along with many Fluorine and Chlorine-containing compounds, but these systems use multiple columns and non-MS detectors, along with PLOT or even packed columns to be able to handle the higher amounts of CO₂ relative to the other trace gases. A system is needed that can analyze compounds that are both less and more retained on cold sorbent traps than CO₂, while removing CO₂ prior to injection of the extracted sample onto a single column GC or GCMS system, even when CO₂ levels are as high as 4% (40,000 PPM) as when measuring stack gas plumes.

US EPA Method OTM-50 as introduced at the end of 2023 has 30 compounds that are either PFAS (Per-Fluorinated Alkyl Substances) or VFCs (Volatile Fluorinated Compounds), with boiling points ranging from −128° C. (CF₄) to about 100° C. OTM-50 is a stack gas sampling method where CO₂ levels are expected to be from 0.5-4% in the final collected gas phase samples. No combination of sorbents at any temperature have been found that retains CF₄ while allowing CO₂ to pass through, so the initial draft release of Method OTM-50 required two separate analyses; one to quantify CF₄ where CO₂ was not first removed, and a second for all of the less volatile compounds, whereby the CO₂ could be removed from the trapping media without the loss of those compounds. CF₄ elutes prior to the very large CO₂ peak using the GC column selected for OTM-50, so CO₂ does not interfere with the CF₄ response, so removal of CO₂ is not necessary when only CF₄ is to be analyzed. However, this first release of OTM-50 was limited to only a volume of 20 cc, due to multiple factors, so less CO₂ was co-injected than the originally desired amount of 200 cc, so CF₄ response was not optimal. When analyzing the rest of the compounds on the OTM-50 list using the desired 200 cc sample volume, the CO₂ must be removed both due to expansion whereby the 0.1 cc optimal injection volume is not achieved, and because co-elution with some of the target compounds results in up to 100% loss of signal in the detector (mass spectrometer).

### SUMMARY OF THE DISCLOSURE

This disclosure relates generally to sample preparation for GCMS analysis and, more particularly, to removing carbon dioxide (CO₂) from a sample while recovering compounds more volatile than CO₂ and compounds less volatile than CO₂. A primary cold sorbent trap concentrates the sample, followed by forward flushing of retained compounds more volatile than CO₂ to a secondary cold sorbent trap. Prior to CO₂ elution, the forward flushing to the secondary trap is stopped, and the primary trap is isolated from the secondary trap. Then, the system removes CO₂ using one of two possible approaches. In one approach, the primary trap is placed under vacuum and warmed while monitoring the expansion of CO₂ from the primary trap, thereby measuring the amount of CO₂ present using the total pressure increase, without using flush gas to remove the CO₂ from the primary trap. In another approach, the system warms the primary trap while the primary trap is isolated from the secondary trap to purge CO₂ from the primary trap without placing the primary trap under vacuum. In some embodiments, the first approach that removes CO₂ from the first trap under vacuum further includes using a small amount of inert gas as needed to eliminate CO₂ interferences with the analysis of the other collected compounds. After the CO₂ is removed, the primary trap is heated and backflushed to the secondary trap, which is then preheated and either injected directly to a GCMS, or further condensed using an open tubular focusing trap for even faster injection rates into the GCMS.

### BRIEF DESCRIPTION OF THE DRAWINGS

FIG. 1 illustrates an example system for removing CO₂ from a chemical sample prior to chemical analysis according to some embodiments of the disclosure.

FIG. 2 illustrates an example process for removing CO₂ from a chemical sample prior to chemical analysis according to some embodiments of the disclosure.

FIGS. 3A-3G illustrate the flow paths facilitated by valve(s) during the steps of process according to some embodiments of the disclosure.

### DETAILED DESCRIPTION

In the following description, reference is made to the accompanying drawings which form a part hereof, and in which it is shown by way of illustration specific examples that can be practiced. It is to be understood that other examples can be used, and structural changes can be made without departing from the scope of the examples of the disclosure.

This disclosure relates generally to sample preparation for GCMS analysis and, more particularly, to removing carbon dioxide (CO₂) from a sample while recovering compounds more volatile than CO₂ and compounds less volatile than CO₂. A primary cold sorbent trap concentrates the sample, followed by forward flushing of retained compounds more volatile than CO₂ to a secondary cold sorbent trap. Prior to CO₂ elution, the forward flushing to the secondary trap is stopped, and the primary trap is isolated from the secondary trap. Then, the system removes CO₂ using one of two possible approaches. In one approach, the primary trap is placed under vacuum and warmed while monitoring the expansion of CO₂ from the primary trap, thereby measuring the amount of CO₂ present using the total pressure increase, without using flush gas to remove the CO₂ from the primary trap. In another approach, the system warms the primary trap while the primary trap is isolated from the secondary trap to purge CO₂ from the primary trap without placing the primary trap under vacuum. In some embodiments, the first approach that removes CO₂ from the first trap under vacuum further includes using a small amount of inert gas as needed to eliminate CO₂ interferences with the analysis of the other collected compounds. After the CO₂ is removed, the primary trap is heated and backflushed to the secondary trap, which is then preheated and either injected directly to a GCMS, or further condensed using an open tubular focusing trap for even faster injection rates into the GCMS.

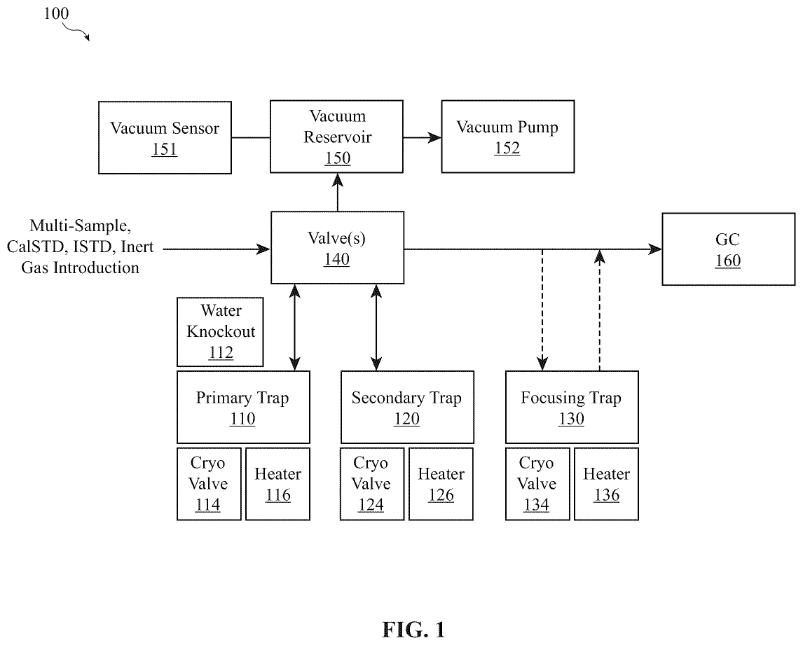

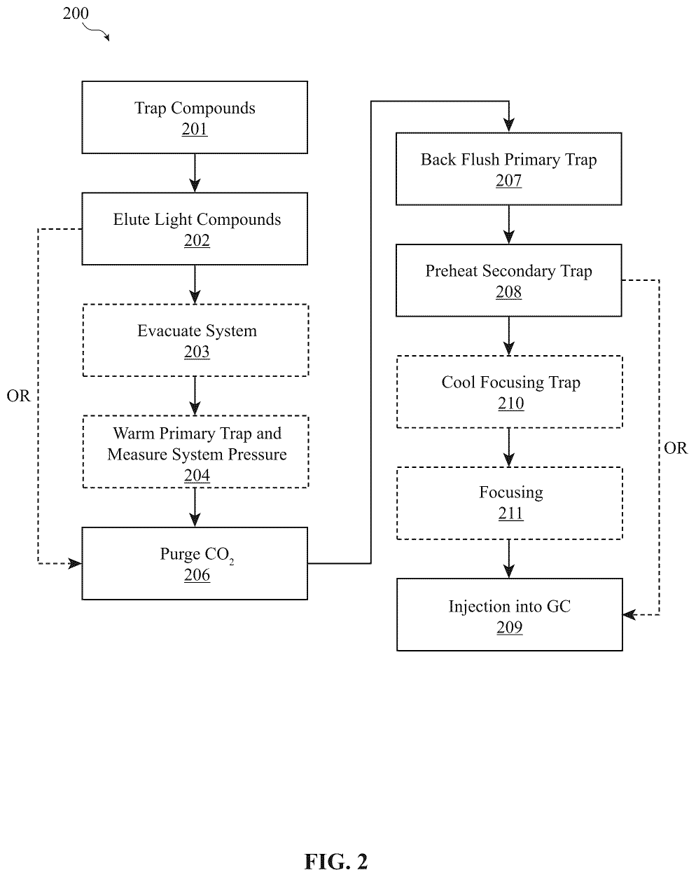

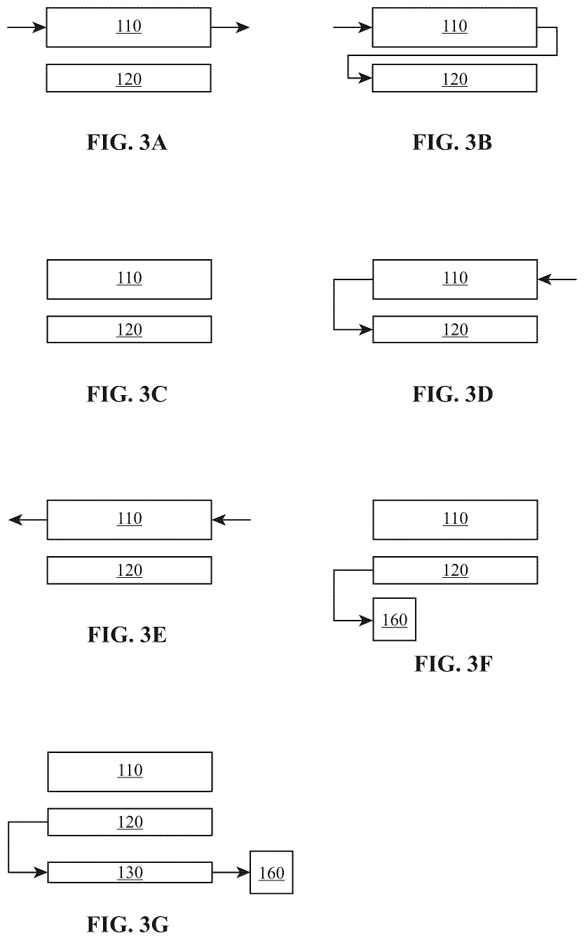

FIG. 1 illustrates an example system for removing CO₂ from a chemical sample prior to chemical analysis according to some embodiments of the disclosure. As shown in FIG. 1, the system includes a primary trap 110, a secondary trap 120, a vacuum reservoir 150, a vacuum sensor 151, a vacuum pump 152, gas chromatograph (GC) 160, one or more valve(s) 140. Optionally, the system 100 further includes a focusing trap 130. The operation of system 100 is described in further detail below with reference to FIGS. 2 and 3.

In some embodiments, valve(s) 140 include one or more rotary valves. Other suitable valves are possible. The valve(s) 140 are connected to the primary trap 110, the secondary trap 120, the vacuum reservoir 150, the vacuum sensor 151, the vacuum pump 152, the GC 160 and, in systems including it, the focusing trap 130. Opening, closing, and/or otherwise changing the configuration of the valve(s) 140 changes the flow path through system 100, including changing which components are connected together, the direction of flow through components, and/or ceasing flow through one or more components. For example, the valve(s) 140 facilitate the flows and no-flow states of primary trap 110, secondary trap 120, and optional focusing trap 130 illustrated in FIGS. 3A-3G.

Valve(s) 140 include an inlet control valve used to select one of a plurality of possible positions to allow different gas streams to flow into system 100. These gas streams can include inert gas, internal standard, calibration standard, and/or gas sample(s). Optionally, the inlet control valve includes multiple inlets connected to samples, and is compatible with an autosampler that automatically connects the samples to enable unattended analysis in production labs.

During the trapping process, an internal standard can be added to the trap to allow determination of the sensitivity of the detector at the time of the analysis. That is, some detectors like mass spectrometers can have absolute sensitivities that fluctuate, so during any given analysis the injection of a known amount of internal standard can allow the absolute sensitivity of the mass spectrometer to be associated with the response of the internal standard, thereby creating a “Relative Response” that is used to get a more accurate analysis of real samples where concentrations of target compounds in samples are to be determined. That is, if the response of the internal standard drops by 10%, it is expected that the response of the target compounds will drop by 10%, so such a drop will not result in an error in the measurement of the target compounds. Calibration standards are mixtures of the target compounds at know concentrations that allow MS response factors to be determine for each compound relative to the response of an internal standard compound so that peak areas in a GCMS analysis can be associated with a given compound concentration. They are also used to check the linearity of the method, to assess the dynamic range of the technique, and to determine method detection limits. These calibration standards are typically run at least daily to make sure the response of the target compounds relative to the internal standard response has not changed more than about +−30%.

Primary trap 110 is a cold trap including one or more sorbent beds. The system 100 further includes a water knockout zone 112, cryovalve 114, and heater 116 in proximity to primary trap 110. For example, the cryovalve 114 can cool the temperature of the primary trap 110 during trapping to the range of −80° C. and −150° C. The cold temperature of primary trap 110 causes the temperature of the water knockout zone 112 to also be in this range and the close proximity of the water knockout trap 112 allows the water knockout trap 112 to be controlled in the range of 0 to −30° C. to limit the amount of moisture that can pass in and out of the primary trap without removal as H₂O(s), or ice. The primary trap 110 traps a sample including compounds less volatile than CO₂, compounds more volatile than CO₂, and CO₂. After trapping the sample, valves 140 facilitate a forward flow through the primary trap 110 to transfer compounds less volatile than CO₂ from the primary trap 110 to the secondary trap 120 in a forward-flow direction.

The primary trap 110 is configured to allow compounds more volatile than CO₂ to elute through the primary trap 110 to the secondary trap 120, and to retain the compounds less volatile than CO₂ during CO₂ removal using one of two approaches described in further detail herein. In one approach, the primary trap 110 is placed under vacuum and warmed while monitoring the expansion of CO₂ from the primary trap 110, thereby measuring the amount of CO₂ present using the total pressure increase, without using flush gas to remove the CO₂ from the primary trap. Optionally, the first approach is followed by using a small amount of inert gas as needed to eliminate CO₂ interferences with the analysis of the other collected compounds. In another approach, the system warms the primary trap while the primary trap is isolated from the secondary trap to purge CO₂ from the primary trap without placing the primary trap under vacuum. To minimize water transfer to the GC 160 and avoid interferences caused by water, water knockout trap 112 remains in the temperature range of 0 and −30° C. while the sample is transferred from the primary trap 110 to the secondary trap 120, only allowing a sample flow with a dew point between 0° C. and −30° C. During this time, the primary trap 110 is heated to a temperature in the range of 100 and 200° C. to release the sample compounds with heater 116. When compounds are transferred from the primary trap 110 to the secondary trap 120 through valves 140, the cold temperature of the water knockout zone 112 can cause water to condense and remain in the water knockout zone 112 instead of proceeding to the secondary trap 120, thereby removing water from the rest of the sample prior to analysis.

Vacuum reservoir 150 and vacuum sensor 151 can be connected together to measure volume during trapping by sensing a change in pressure in vacuum reservoir 150. If the vacuum reservoir 150 volume is 600 cc, for example, a change of ⅓ atmospheres would require that a volume of ⅓×600 cc=200 cc be passed through the primary trap 110 and into the vacuum reservoir 150. Likewise, the system can monitor the sample volume during other steps of the sample preparation process based on measuring changes in the pressure of vacuum reservoir 150 with vacuum sensor 151. When heating the primary trap 110 to the point where CO₂ becomes mobile, vacuum sensor 151 can measure the increase of the pressure in vacuum reservoir 150, the increase of which will be proportional to the amount of CO₂ that was collected in the trap. This increase can be used to add to the volume recovered in the vacuum reservoir 150 that was condensed in the primary trap 110 during original sample trapping. Knowing the approximate concentration of the CO₂ in the sample from 0.1 to 4% can add value to the analysis, as opposed to other approaches that cannot approximate the amount of CO₂ in the sample. In addition, using the CO₂ as its own purge gas has a major advantage when larger amounts of CO₂ are trapped. During the initial purging of compounds lighter and/or more volatile than CO₂ to the secondary trap, the CO₂ will move further into the trap than where it was initially trapped, and where it will be partially separated from the less volatile compounds remaining in the primary trap. Therefore, during expansion of up to 8 cc of CO₂ from the primary trap in the forward flow direction, the less volatile compounds that have not penetrated as far into that trap will hardly experience any flow volume in the forward direction, meaning they will have no reason to move forward and out of the primary trap at this point with the expanding CO₂. Therefore, this may allow larger amounts of CO₂ to be trapped and eliminated without loss of the slightly less volatile compounds of interest on the primary trap.

Vacuum pump 152 can draw a vacuum in system 100 or just the vacuum reservoir 150. When drawing a vacuum on the whole system 100, the temperature of primary trap 110 needs to be sufficiently cold to retain CO₂ to allow the amount of CO₂ to be measured later. Connecting the vacuum pump 152 to the inlet control valves can evacuate and flush the inlet control valves. Thus, the vacuum pump 152 can be switchably coupled to the vacuum reservoir 150, to the whole system 100, or disconnected.

During removal of CO₂, the system 100 can be placed under vacuum by opening one or more valves connecting the vacuum pump 152 to other components of the system 100, such as the primary trap 110. At this time, the valve(s) 140 connecting the various gas sources to the inlet of the system 100 are off. In this way, the only gas flow is the expanding CO₂ which is beyond the point of less volatile compound deposition on the primary trap, substantially reducing the potential for loss of the other compounds on the primary trap 110, relative to strictly using a flush technique to remove the CO₂, by using less purge gas. This approach also brings the remaining amount of CO₂ to be purged off the primary trap 110 to a more consistent level, whether the original sample had 0.1% or 4% CO₂.

Secondary trap 120 is a cold trap with a narrower inner diameter than that of the primary trap 110 to allow faster injection rates to the GC 160 upon desorption of the secondary trap 120. For example, the inner diameter of the primary trap 110 can be 2-2.5 mm and the inner diameter of the secondary trap 120 can be 1 mm. The system 100 further includes a cryovalve 124 and heater 126 in proximity to the secondary trap 120. Secondary trap 120 remains cold during transfer of compounds from the primary trap 110 to the secondary trap and is heated (e.g., with heater 126) during transfer of compounds from the secondary trap 120 to the GC 160, optionally through focusing trap 130, as described in further detail with reference to FIGS. 2 and 3.

Some embodiments include focusing trap 130. Focusing trap 130 is an open tubular column that can be operated at near liquid Nitrogen temperatures. Focusing trap 130 reduces the volume of the sample after CO₂ removal and prior to analysis by GC 160.

In some embodiments, the valve(s) 140 connect the focusing trap 130 between the secondary trap 120 and the GC 160, with the sample moving through focusing trap 130 in a forward direction. In other words, the sample enters a first end of the focusing trap 130 from the secondary trap 120 and exits the focusing trap from a second end, different from the first end, of the focusing trap 130 to transfer to the GC 160 for analysis.

FIG. 2 illustrates an example process 200 for removing CO₂ from a chemical sample prior to chemical analysis according to some embodiments of the disclosure. The system 100 described above with reference to FIG. 1, and further detailed with reference to FIGS. 2-3, performs process 200. Process 200 preconcentrates a sample containing very light to heavier chemicals in the presence of CO₂ and removes some to most of the CO₂. Removing CO₂ from the sample is necessary to obtain the best results when analyzing the remaining compounds by capillary GC or GCMS. As an example, the sample can include CF₄, a compound that is less readily retained than CO₂ on virtually all sorbents at any temperature and that must be captured while eliminating most of the CO₂. Samples prepared according to the examples herein may also include Methane, Xenon, Krypton, NF₃ and other chemicals less readily retained by the traps than CO₂. In some embodiments, process 200 is performed according to the order in which the steps are described herein. In some embodiments, process 200 is performed in a different order. Steps may be repeated or skipped in some variations of process 200 without departing from the scope of the disclosure.

FIGS. 3A-3G illustrate the flow paths facilitated by valve(s) 140 during the steps of process 200 according to some embodiments of the disclosure. The valve(s) 140 control the flow of gas in, out, and through primary trap 110 and secondary trap 120.

In step 201, the primary trap 110 is used to capture all compounds while allowing Nitrogen, Oxygen, and Argon to pass through the primary trap 110 unretained. During step 201, valve(s) 140 allow the sample to flow through primary trap 110 in a first direction, as shown in FIG. 3A. The sample enters a first end of primary trap 110 and the lightest compounds exit the primary trap 110 through a second end of the primary trap 110. These fixed gases boil between −180° C. −196° C., and can be readily removed from the system 100 while trapping other compounds boiling above −160° C. when using the appropriate sorbent, for example. The primary trap 110 is cooled down to a low enough temperature to allow all target compounds to be retained by the primary trap 110. During this time, secondary trap 120 and optional focusing trap 130, if used, are not connected to the primary trap 110. For example, during trapping, cryovalve 114 cools the primary trap 110 to a temperature in the range of −120° C. to −150° C. During step 201, secondary trap 120 and optional focusing trap 130 are not temperature-controlled as they are not in the flow path during initial sample trapping.

Typically, sorbents can get up to 10 times stronger for every 35° C. their temperatures are reduced, with some variation in changes in trapping strength verified experimentally. Therefore, one or more sorbents are used in the primary trap 110 such that when operating at reduced temperatures (−20° C. to −160° C., for example), the primary trap 110 is strong enough to prevent the lightest target compounds from breaking through the primary trap 110 at the maximum trapping volume needed to reach required detection limits (e.g., 200 cc to reach 0.001 PPB using SIM Mode or SRM Mode (EI-MSMS)). The volume of gas passing through the primary trap 110 can be determined using a mass flow controller and time integration, using a fixed restrictor if both the inlet and outlet pressures are constant, or using vacuum reservoir 150 and the ideal gas law, PV=nRT, to determine the amount of gas that has passed through the primary trap 110. When using a mass flow controller to measure the volume of gas passing through the primary trap 110, process 200 includes a standard purge, rather than a vacuum purge, to remove CO₂. After trapping, an inert gas also used as the GC carrier gas, such as Helium or Hydrogen can be passed through the primary trap 110 to eliminate the rest of the N₂, O₂, and Ar that may not have cleared the primary trap 110.

In some approaches, the system 100 uses a mass flow controller to measure the purge gas and sample entering primary trap 110. Using a mass flow controller in this way can increase the chances of carryover occurring between samples, especially when analyzing highly concentrated samples, because the sample flows through the mass flow controller. If a high concentration sample is experienced, then absorption or transfer into dead volume within the MFC can occur, causing carryover in subsequent analyses. As described in more detail below, in some embodiments, the system 100 measures CO₂ using vacuum reservoir 150, thereby avoiding this problem.

In step 202, the temperature of the primary trap 110 can be increased to allow compounds more volatile than CO₂ to be purged completely through the primary trap 110 for delivery to a secondary trap 120 that, through a combination of sorbent strength and low temperature, is able to retain the light-eluting compounds, such as CF₄ (boiling point=−127° C.), NF₃ (boiling point=−128° C.), one of the other examples above, and/or other compounds of interest in the analysis more volatile than CO₂. That is, in this case the primary trap 110 is used as a packed GC column to separate the more volatile compounds from the less volatile compounds, thereby separating them to allow the more volatile compounds to elute from the primary trap 110 functioning as a packed GC column to then be trapped on the secondary trap 120. During step 202, valve(s) 140 control the flow of sample from primary trap 110 to secondary trap 120 as shown in FIG. 3B. Primary trap 110 is forward flushed; compounds exit the primary trap 110 in step 202 from a different end of the primary trap 110 than the end through which they entered the primary trap 110 in step 201, in the same direction from the flow of the compounds in step 201. During step 202, cryovalve 114 controls the temperature of the primary trap 110 to set a temperature that is too cold to elute CO₂ (and compounds of interest that are less volatile than CO₂) but warm enough to allow ultra volatile compounds of interest (e.g., CF₄ and/or NF₃) to purge through primary trap 110, such as a temperature in the range of −30° C. to −110° C., depending on the sorbent used in the primary trap 110. However, during step 202, the CO₂ can move further into the primary trap 110 than the less volatile compounds, allowing the potential for later forward expansion flow of the CO₂ while compounds slightly less volatile than CO₂ will experience very little forward flow as they are now “behind” the CO₂ on the primary trap 110 relative to the forward flow direction, and therefore have very little chance for loss through the forward flow direction.

In some embodiments, after step 202, the method proceeds to step 206 to purge CO₂ while the primary trap 110 has positive pressure. In other embodiments described below, the method includes steps 203 and/or 204 between steps 202 and 206 to use a vacuum to remove CO₂. In some embodiments not including steps 203 and 204, after step 202, the method includes altering the flow path to take the secondary trap 120 out of line with the primary trap 110 then proceeding to step 206. In step 206, heater 116 warms up the primary trap 110 to a temperature that allows forward purging of the CO₂ out of the primary trap 110 while the system 100 purges out the CO₂ without loss of the remaining compounds. This approach is appropriate for samples that do not include compounds light enough to be lost during the purge of CO₂ from the primary trap 110 and/or for samples including a relatively low concentration of CO₂. For samples including one or more of the additional compounds that can potentially elute during CO₂ removal, or when higher levels of CO₂ are present (0.2%, 4% or higher), additional steps 203 and/or 204 may be used, as will now be explained.

In step 203, the primary trap 110 is isolated again from the secondary trap 120, and a vacuum is pulled on the primary trap 110 (and portions of the system 100 fluidly coupled to the primary trap 110) using vacuum pump 152, followed by isolation of the vacuum pump 152 from the system 100 and the primary trap 110. At this time, the inlet to the system 100 must be closed to allow this vacuum to be formed. During step 203, the valve(s) 140 stop the flow through primary trap 110 and disconnects the primary trap 110 and secondary trap 120, as shown in FIG. 3C. Valve(s) 140 connects the primary trap 110 to the vacuum reservoir 150, connected to the vacuum pump 152. Because the secondary trap 120 is not inline with the primary trap 110 during step 203, secondary trap 120 is not evacuated during step 203.

In step 204, the primary trap 110 is warmed to the point where the CO₂ becomes mobile on the primary trap 110. Due to the significant volume of the CO₂ contained in the primary trap 110 relative to all other trace level compounds, the expansion can be measured using vacuum sensor 151 and vacuum reservoir 150 for samples including 0.2% to 4% CO₂. For samples including less than 0.2% CO₂, such as when analyzing ambient or indoor air quality, steps 203 and 204 can be skipped. During step 204, the valve(s) 140 open both ends of the primary trap 110 and isolate the primary trap 110 from the secondary trap 120, as shown in FIG. 3A and induce a flow through primary trap 110 into the vacuum reservoir. Thus, the flow through primary trap 110 during step 204 is in the same direction as the flow during step 201. The primary trap 110 is connected to the vacuum reservoir 150 during step 204.

If, during step 201, a mass flow controller (MFC) is used to measure the sample volume, with the MFC in front of the primary trap 110, then the CO₂ will be added to the total measurement, with a slight error as CO₂ has a 30% difference response for MFCs calibrated for air or Nitrogen. However, if the MFC or a vacuum reservoir 150 to measure the collected volume is downstream of the primary trap 110, then the CO₂ will be removed in the primary trap 110 and will not be added to the total volume measured downstream, which can cause up to a 4% error when CO₂ is 4% of the sample. However, by measuring the expansion of CO₂ and knowing the volume of the trapping system 100, this volume can be accounted for when making the calculations. Therefore, if 8 cc of volume were recorded using a vacuum reservoir 150 technique in step 201, followed by a 0.2 psi increase in pressure during the expansion of CO₂ into a vacuum reservoir 150 with a volume of 600 cc, then the volume actually trapped in step 201 would have been 208 cc, and that volume can be used during data processing to eliminate the 4% error that would otherwise exist. The vacuum sensor 151 coupled to the vacuum reservoir 150 can measure changes in pressure within +/−0.01 psia, allowing the system 100 to measure CO₂ in samples containing 0.2% to 4% CO₂.

In addition, the elimination of the CO₂ from the primary trap 110 using this vacuum expansion approach has another advantage. Normally, the amount of flush gas needed to remove 8 cc of CO₂ from the primary trap may be 30-50 cc or more, at which point it may be difficult to keep other light compounds that are almost as volatile as CO₂ on the trap. However, since CO₂ is more volatile than even the next most volatile compound, it will have migrated further into the primary trap during initial trapping and when forward purging the lightest compound(s) (e.g., CF₄, Methane) to the secondary trap, such that most of the expansion will not be pushing the next lightest compounds in the direction of the trap exit, so there should be very little movement of the next lightest compounds in that direction, so far less opportunity for them to be lost during the CO₂ removal step.

In step 206, a small amount of purge gas (e.g., ultra-high purity N₂ or He) can be used to remove any residual CO₂ left in the primary trap 110. This residual amount of CO₂ should be fairly consistent from sample to sample once CO₂ expansion is complete during step 204 During step 206, the valve(s) 140 isolate the secondary trap 120 and facilitate flow through the primary trap 110 as shown in FIG. 3A. The flow through primary trap 110 during step 206 is in the same direction as the flow into primary trap 110 during step 201; compounds exit the primary trap 110 in step 206 through the opening of primary trap 110 through which the compounds exited primary trap 110 during step 201. In some embodiments, such as in implementations including steps 203 and/or 204, the primary trap 110 is at vacuum when step 206 occurs. In some embodiments, such as in implementations not including steps 203 and/or 204, the primary trap is at positive pressure when step 206 occurs. The primary trap is optionally at a temperature in the range of −20° C. to −80° C. during step 206.

In step 207, the compounds remaining in the primary trap 110 are transferred to the secondary trap 120 by optionally first preheating the primary trap 101 with heater 116, and then backflushing the primary trap 110 with continued heating with heater 116 to deliver the rest of the sample to the cold secondary trap 120. The secondary trap 120 then contains all target compounds, with the CO₂ effectively removed. Valve(s) 140 configure the primary trap 110 and the secondary trap 120 and facilitate flow from the primary trap 110 to the secondary trap 120 during step 207 as shown in FIG. 3D. During step 207, heater 116 heats primary trap 110 to a temperature in the range of 100° C. to 200° C.

In step 208, the secondary trap 120 is preheated under a no flow condition to allow a faster release rate once the flow towards the GC 160 is created. During step 208, the valve(s) 140 isolate the primary trap 110 and secondary trap 120 from other parts of the system 100 as shown in FIG. 3C and as described above with reference to step 203 and FIG. 3C. Even when using a detector that is not affected by a large amount of CO₂, any CO₂ that was not removed from the sample would create a defocusing of the sample by expanding compounds in both directions of secondary trap 120 during pre-heating, as the CO₂ becomes volatile. Therefore, the sample would not be injected quickly because the volume would be effectively too large, and perhaps well over the maximum 0.1 cc total volume as explained earlier. In addition, since the peak width during gas chromatography is related to the diffusion rate of the target compounds relative to the carrier gas, a large volume of CO₂ co-eluting with some target compounds would effectively require those compounds to be subjected to a CO₂ carrier gas composition, which would have a much lower diffusive rate than typical GC carrier gases (Helium and Hydrogen), causing the peaks to be very broad and poorly resolved from each other. Therefore, removal of the CO₂ will not only prevent signal attenuation at the detector (mass spectrometer, others), but will also have other undesirable effects on the analysis.

In step 209, the secondary trap 120 is connected in line with the flow of carrier gas to the GC 160 to transfer the sample quickly to the GC column. An optional focusing trap 130 can be used to focus the sample at near liquid Nitrogen temperatures to allow an even faster GC injection rate and even narrower peaks on-column. For example, process 200 includes step 210 to cool the focusing trap and step 211 to focus the sample using the focusing trap. With narrow peaks, less time and GC column resolving power will be needed to separate the compounds of interest. That is, if a GC peak is only 3 seconds wide, it will only have to separate by 3 seconds from a nearby peak to obtain baseline resolution, whereas a 6 second wide peak would require a separation of 6 seconds, thereby requiring a longer column, thicker column film, and typically a longer analysis time, thereby affecting laboratory productivity. CF₄ and other ultra light and/or highly volatile compounds may break through the focusing trap 130, but they have unique ions and will be well separated from those less volatile compounds that were retained by the focusing trap 130, so for these compounds, achieving the most narrow peak widths and separation for other compounds is less important. Step 211 occurs while secondary trap 120 is heated to a temperature in the range of 150° C. to 200° C. using heater 136. After focusing, the focusing trap 130 is heated to 50-100° C. during step 209 to rapidly release all compounds of interest to the GCMS. A lower desorption temperature can be used than with the primary trap 110 or secondary trap 120, as the focusing trap 130 has no internal sorbents, and simply uses extremely cold temperatures to retain the target compounds.

FIG. 3F illustrates an example of the flow from secondary trap 120 to GC 160 facilitated by valve(s) 140 in systems not including the focusing trap 130. As shown in FIG. 3F, the valve(s) 140 facilitate flow from the secondary trap 120 in a direction opposite from the direction of flow into the secondary trap 120 during steps 202 and 207; compounds exit secondary trap 120 in step 209 through the opening of secondary trap 120 through which the compounds entered the secondary trap 120 in steps 202 and 207.

FIG. 3G illustrates an example of the flow from secondary trap 120, through focusing trap 130, to GC 160 facilitated by valve(s) 140 and temperature control of focusing trap 130 in systems including the focusing trap 130. As shown in FIG. 3G, the valve(s) 140 facilitate flow from the secondary trap 120 in a direction opposite from the direction of flow into the secondary trap 120 during steps 202 and 207; compounds exit secondary trap 120 in step 211 through the opening of secondary trap 120 through which the compounds entered the secondary trap 120 in steps 202 and 207. The compounds proceed through the focusing trap 130 into the GC 160, entering the focusing trap 130 at one end and exiting the focusing trap 130 at another end. Alternatively, a PLOT column can be used for focusing to ensure even the CF₄ and other ultralight and/or highly volatile compounds are retained, but in either cases, the focusing trap can be forward purged to the GC 160, rather than backflushed.

Techniques described herein analyze any gas containing trace volatile compounds by GCMS when the list of target compounds includes those that are both more volatile and less volatile than CO₂, related to their ability to be collected on a sorbent trap at specific trapping temperatures. Greenhouse gases have this requirement, as many are more volatile than CO₂, while others are less volatile. In particular, US EPA Method OTM-50 for the analysis of PFAS/VFC compounds from C1 to C8 in stack gas can substantially benefit by the use of this new solution. Standard preconcentration technology that has been used to analyze toxic chemicals in air (EPA method TO-14A, TO-15, TO-15A) must use two separate analyses, one to first measure CF₄ at low volumes due to the inability to remove the CO₂, and therefore limited to those volumes that will not cause over-expansion of the focused gases as CO₂ must be injected into the GC, and a second analysis whereby the CF₄ and CO₂ are purged off, followed by analysis of the C2 PFAS, C1 VFC, and all less volatile compounds. With this new trapping system that uniquely eliminates CO₂ while quantitatively recovering all other compounds in OTM-50 and at a full volume of 200 cc, the cost per sample analysis is reduced (1 run instead of 2 runs), while the sensitivity of the lightest compound CF₄ is improved due to the ability to trap and inject a larger volume of sample gas.

Therefore, according to the above, some embodiments of the disclosure are directed to a method performed at a system including a primary trap, a secondary trap, a gas chromatograph (GC), and one or more valves. Additionally or alternatively, in some embodiments, the method includes trapping, using the primary trap, first compounds more volatile than carbon dioxide (CO₂), second compounds less volatile than CO₂, and CO₂, including facilitating a flow in a first direction, using the one or more valves, into the primary trap through a first opening of the primary trap. Additionally or alternatively, in some embodiments, the method includes, after trapping the first compounds, second compounds, and the CO₂, eluting, using the one or more valves, the first compounds from the primary trap to the secondary trap while retaining the CO₂ and second compounds with the primary trap, including facilitating a flow in the first direction, using the one or more valves, out of the primary trap through a second opening of the primary trap different from the first opening of the primary trap. Additionally or alternatively, in some embodiments, the method includes after eluting the first compounds from the primary trap to the secondary trap, purging, using the one or more valves and an inert gas, the CO₂ from the primary trap without transferring the CO₂ to the secondary trap while retaining the second compounds with the primary trap. Additionally or alternatively, in some embodiments, the method includes, after purging the CO₂ from the primary trap, transferring, using the one or more valves, the second compounds from the primary trap to the secondary trap, including backflushing the second compounds in a flow in a second direction opposite the first direction out of the first opening of the primary trap. Additionally or alternatively, in some embodiments, after transferring the second compounds from the primary trap to the secondary trap, injecting, using the one or more valves, the first compounds and the second compounds into the GC for analysis by gas chromatography or gas chromatograph-mass spectrometry without injecting the CO₂ into the GC. Additionally or alternatively, in some embodiments, the method includes after eluting the first compounds from the primary trap and while opening the first opening of the primary trap using the one or more valves, isolating the secondary trap from the primary trap with the one or more valves, and while isolating the secondary trap from the primary trap with the one or more valves, increasing a temperature of the primary trap to mobilize the CO₂ from the primary trap; and retaining the second compounds on the primary trap and retaining the first compounds on the secondary trap. Additionally or alternatively, in some embodiments, the method includes, after eluting the first compounds from the primary trap and while opening the first opening of the primary trap using the one or more valves and while the temperature of the primary trap is increased to mobilize the CO₂ from the primary trap: coupling, using the one or more valves, the primary trap to a vacuum reservoir; and measuring, using a vacuum sensor, a change in pressure of the system to measure a quantity of the CO₂. Additionally or alternatively, in some embodiments, pressure in the primary trap is above atmospheric pressure while purging the CO₂ from the primary trap. Additionally or alternatively, in some embodiments, the method includes, after eluting the first compounds from the primary trap to the secondary trap, reducing pressure in the primary trap before and/or while purging CO₂ from the primary trap. Additionally or alternatively, in some embodiments, the method includes, after transferring the second compounds to the secondary trap: cooling a focusing trap; and transferring, with the one or more valves, the first compounds and the second compounds from the secondary trap to a focusing trap to reduce a volume of the first compounds and the second compounds.

Some embodiments of the disclosure are directed to a system comprising a primary trap including a first end and a second end opposite the first end configured to trap first compounds more volatile than carbon dioxide (CO₂), second compounds less volatile than CO₂, and CO₂. Additionally or alternatively, in some embodiments, the system includes a secondary trap. Additionally or alternatively, in some embodiments, the system includes a gas chromatograph (GC). Additionally or alternatively, in some embodiments, the system includes one or more valves. In some embodiments, the one or more valves are configured to, while the primary trap traps the first compounds, second compounds, and CO₂, facilitating a flow in a first direction into the primary trap through the first opening of the primary trap. Additionally or alternatively, in some embodiments, the one or more valves are configured to, after trapping the first compounds, second compounds, and the CO₂, elute the first compounds from the primary trap to the secondary trap while retaining the CO₂ and second compounds with the primary trap, including facilitating a flow in the first direction, using the one or more valves, out of the primary trap through a second opening of the primary trap different from the first opening of the primary trap. Additionally or alternatively, in some embodiments, the one or more valves are configured to, after eluting the first compounds from the primary trap to the secondary trap, purge, using an inert gas, the CO₂ from the primary trap without transferring the CO₂ to the secondary trap while retaining the second compounds with the primary trap. Additionally or alternatively, in some embodiments, the one or more valves are configured to, after purging the CO₂ from the primary trap, transfer the second compounds from the primary trap to the secondary trap, including backflushing the second compounds in a flow in a second direction opposite the first direction out of the first opening of the primary trap. Additionally or alternatively, in some embodiments, the one or more valves are configured to, after transferring the second compounds from the primary trap to the secondary trap, inject the first compounds and the second compounds into the GC for analysis by gas chromatography or gas chromatography-mass spectrometry without injecting the CO₂ into the GC. Additionally or alternatively, in some embodiments, the one or more valves are further configured to, after eluting the first compounds from the primary trap, open the first opening of the primary trap and isolate the secondary trap from the primary trap; the system further comprising a heater configured to, while isolating the secondary trap from the primary trap with the one or more valves, increasing a temperature of the primary trap to mobilize the CO₂ from the primary trap, wherein the primary trap is further configured to retain the second compounds while the one or more valves open the first opening of the primary trap and isolate the secondary trap from the primary trap; and retaining the first compounds on the secondary trap while the one or more valves open the first opening of the primary trap and isolate the secondary trap from the primary trap. Additionally or alternatively, in some embodiments, the system further includes a vacuum sensor configured to measure a change in pressure of the system to measure a quantity of the CO₂ after the one or more valves elute the first compounds from the primary trap and while the one or more valves open the first end of the primary trap and while the temperature of the primary trap is increased to mobilize the CO₂ from the primary trap; and vacuum reservoir wherein the one or more valves are further configured to couple the primary trap to the vacuum reservoir. Additionally or alternatively, in some embodiments pressure in the primary trap is above atmospheric pressure while purging the CO₂ from the primary trap. Additionally or alternatively, in some embodiments, the system further includes a vacuum pump configured to, after the first compounds are eluted from the primary trap to the secondary trap, reduce pressure in the primary trap before and/or while CO₂ is purged from the primary trap. Additionally or alternatively, in some embodiments, the system includes a focusing trap configured to be cooled after the one or more valves transfer the second compounds to the secondary trap, wherein the one or more valves are further configured to transfer the first compounds and the second compounds from the secondary trap to a focusing trap to reduce a volume of the first compounds and the second compounds.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method comprising:
at a system including a primary trap, a secondary trap, a gas chromatograph (GC), and one or more valves:
trapping, using the primary trap, first compounds more volatile than carbon dioxide (CO₂), second compounds less volatile than CO₂, and CO₂, including facilitating a flow in a first direction, using the one or more valves, into the primary trap through a first opening of the primary trap;
after trapping the first compounds, second compounds, and the CO₂, eluting, using the one or more valves, the first compounds from the primary trap to the secondary trap while retaining the CO₂ and second compounds with the primary trap, including facilitating a flow in the first direction, using the one or more valves, out of the primary trap through a second opening of the primary trap different from the first opening of the primary trap;
after eluting the first compounds from the primary trap to the secondary trap, purging, using the one or more valves and an inert gas, the CO₂ from the primary trap without transferring the CO₂ to the secondary trap while retaining the second compounds with the primary trap;
after purging the CO₂ from the primary trap, transferring, using the one or more valves, the second compounds from the primary trap to the secondary trap, including backflushing the second compounds in a flow in a second direction opposite the first direction out of the first opening of the primary trap; and
after transferring the second compounds from the primary trap to the secondary trap, injecting, using the one or more valves, the first compounds and the second compounds into the GC for analysis by gas chromatography or gas chromatograph-mass spectrometry without injecting the CO₂ into the GC.

2. The method of claim 1, further comprising:
after eluting the first compounds from the primary trap and while opening the first opening of the primary trap using the one or more valves:
isolating the secondary trap from the primary trap with the one or more valves; and
while isolating the secondary trap from the primary trap with the one or more valves:
increasing a temperature of the primary trap to mobilize the CO₂ from the primary trap; and
retaining the second compounds on the primary trap and retaining the first compounds on the secondary trap.

3. The method of claim 2, further comprising, after eluting the first compounds from the primary trap and while opening the first opening of the primary trap using the one or more valves and while the temperature of the primary trap is increased to mobilize the CO₂ from the primary trap:
coupling, using the one or more valves, the primary trap to a vacuum reservoir; and
measuring, using a vacuum sensor, a change in pressure of the system to measure a quantity of the CO₂.

4. The method of claim 1, wherein pressure in the primary trap is above atmospheric pressure while purging the CO₂ from the primary trap.

5. The method of claim 1, further comprising:
after eluting the first compounds from the primary trap to the secondary trap, reducing pressure in the primary trap before and/or while purging CO₂ from the primary trap.

6. The method of claim 1, further comprising:
after transferring the second compounds to the secondary trap:
cooling a focusing trap; and
transferring, with the one or more valves, the first compounds and the second compounds from the secondary trap to a focusing trap to reduce a volume of the first compounds and the second compounds.

7. A system comprising:
a primary trap including a first end and a second end opposite the first end configured to trap first compounds more volatile than carbon dioxide (CO₂), second compounds less volatile than CO₂, and CO₂;
a secondary trap;
a gas chromatograph (GC); and
one or more valves configured to:
while the primary trap traps the first compounds, second compounds, and CO₂, facilitating a flow in a first direction into the primary trap through the first opening of the primary trap;
after trapping the first compounds, second compounds, and the CO₂, elute the first compounds from the primary trap to the secondary trap while retaining the CO₂ and second compounds with the primary trap, including facilitating a flow in the first direction, using the one or more valves, out of the primary trap through a second opening of the primary trap different from the first opening of the primary trap;
after eluting the first compounds from the primary trap to the secondary trap, purge, using an inert gas, the CO₂ from the primary trap without transferring the CO₂ to the secondary trap while retaining the second compounds with the primary trap;
after purging the CO₂ from the primary trap, transfer the second compounds from the primary trap to the secondary trap, including backflushing the second compounds in a flow in a second direction opposite the first direction out of the first opening of the primary trap; and
after transferring the second compounds from the primary trap to the secondary trap, inject the first compounds and the second compounds into the GC for analysis by gas chromatography or gas chromatography-mass spectrometry without injecting the CO₂ into the GC.

8. The system of claim 7, wherein:
the one or more valves are further configured to, after eluting the first compounds from the primary trap, open the first opening of the primary trap and isolate the secondary trap from the primary trap; the system further comprising:
a heater configured to, while isolating the secondary trap from the primary trap with the one or more valves, increasing a temperature of the primary trap to mobilize the CO₂ from the primary trap, wherein:
the primary trap is further configured to retain the second compounds while the one or more valves open the first opening of the primary trap and isolate the secondary trap from the primary trap; and
retaining the first compounds on the secondary trap while the one or more valves open the first opening of the primary trap and isolate the secondary trap from the primary trap.

9. The system of claim 8, further comprising:
a vacuum sensor configured to measure a change in pressure of the system to measure a quantity of the CO₂ after the one or more valves elute the first compounds from the primary trap and while the one or more valves open the first end of the primary trap and while the temperature of the primary trap is increased to mobilize the CO₂ from the primary trap; and
vacuum reservoir wherein the one or more valves are further configured to couple the primary trap to the vacuum reservoir.

10. The system of claim 7, wherein pressure in the primary trap is above atmospheric pressure while purging the CO₂ from the primary trap.

11. The system of claim 7, further comprising a vacuum pump configured to, after the first compounds are eluted from the primary trap to the secondary trap, reduce pressure in the primary trap before and/or while CO₂ is purged from the primary trap.

12. The system of claim 7, further comprising:
a focusing trap configured to be cooled after the one or more valves transfer the second compounds to the secondary trap, wherein the one or more valves are further configured to transfer the first compounds and the second compounds from the secondary trap to a focusing trap to reduce a volume of the first compounds and the second compounds.
